(19) United States
(12) Patent Application Publication
(10) Pub. No.: US 2026/0045429 A1
(43) Pub. Date: Feb. 12, 2026

(54) SUBSTRATE CIRCUIT FOR KEYBOARD

(71) Applicant: Dell Products L.P., Round Rock, TX (US)

(72) Inventors: Wen Pin HUANG, New Taipei City (TW); Po Chun HOU, Taiwan City (TW); Yi Chen WANG, Taoyuan City (TW); Hsien Tsan CHANG, Taoyuan City (TW)

(73) Assignee: Dell Products L.P., Round Rock, TX (US)

(21) Appl. No.: 18/800,515

(22) Filed: Aug. 12, 2024

(51) Int. Cl. H01H 13/7073; H01H 13/785

(52) U.S. Cl. CPC H01H 13/7073; H01H 13/785; H01H 2219/014

(57) ABSTRACT

A keyboard may comprising plurality of keys, each key of the plurality of keys comprising a circuit assembly comprising and a keycap. The circuit assembly may include a substrate, a first metal layer patterned into a circuit and formed on the substrate, and a membrane comprising a second metal layer interfaced between a first electrically-insulative layer and a second electrically-insulative layer, and assembled to the first metal layer such that the first electrically-insulative layer is interfaced between the first metal layer and the second metal layer. The keycap may be mechanically coupled to the circuit assembly via a mechanical member having a spring force biased to separate the keycap from the circuit assembly by a predetermined distance, such that when a force is applied to the keycap to overcome the spring force, the first metal layer comes in physical contact with the second metal layer.

### TECHNICAL FIELD

The present disclosure relates in general to information handling systems, and more specifically to a substrate circuit for a keyboard.

### BACKGROUND

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Information handling systems often include a keyboard or other similar input device to enable a user to enter data and commands. Particularly in laptop and notebook computers, it may be desirable that keyboard thicknesses be as thin as possible. Keyboard thickness is limited by each keyboard component, including for each key a keycap, scissor, membrane, metal plate, and backlight. Thus, systems and methods to minimize keyboard thickness are desired.

### SUMMARY

In accordance with the teachings of the present disclosure, the disadvantages and problems associated with existing keyboards may be reduced or eliminated.

In accordance with embodiments of the present disclosure, a keyboard may comprising plurality of keys, each key of the plurality of keys comprising a circuit assembly comprising and a keycap. The circuit assembly may include a substrate, a first metal layer patterned into a circuit and formed on the substrate, and a membrane comprising a second metal layer interfaced between a first electrically-insulative layer and a second electrically-insulative layer, and assembled to the first metal layer such that the first electrically-insulative layer is interfaced between the first metal layer and the second metal layer. The keycap may be mechanically coupled to the circuit assembly via a mechanical member having a spring force biased to separate the keycap from the circuit assembly by a predetermined distance, such that when a force is applied to the keycap to overcome the spring force, the first metal layer comes in physical contact with the second metal layer.

In accordance with these and other embodiments of the present disclosure, an information handling system may include a processor and a keyboard communicatively coupled to the processor, the keyboard comprising a circuit assembly comprising and a keycap. The circuit assembly may include a substrate, a first metal layer patterned into a circuit and formed on the substrate, and a membrane comprising a second metal layer interfaced between a first electrically-insulative layer and a second electrically-insulative layer, and assembled to the first metal layer such that the first electrically-insulative layer is interfaced between the first metal layer and the second metal layer. The keycap may be mechanically coupled to the circuit assembly via a mechanical member having a spring force biased to separate the keycap from the circuit assembly by a predetermined distance, such that when a force is applied to the keycap to overcome the spring force, the first metal layer comes in physical contact with the second metal layer.

In accordance with these and other embodiments of the present disclosure, a method for making a keyboard may comprise assembling a circuit assembly by patterning a first metal layer into a circuit on a substrate, interfacing a membrane comprising a second metal layer between a first electrically-insulative layer and a second electrically-insulative layerm and assembling the membrane to the first metal layer such that the first electrically-insulative layer is interfaced between the first metal layer and the second metal layer.

Technical advantages of the present disclosure may be readily apparent to one skilled in the art from the figures, description and claims included herein. The objects and advantages of the embodiments will be realized and achieved at least by the elements, features, and combinations particularly pointed out in the claims.

It is to be understood that both the foregoing general description and the following detailed description are examples and explanatory and are not restrictive of the claims set forth in this disclosure.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1 illustrates a block diagram of an example information handling system, in accordance with embodiments of the present disclosure;

FIG. 2 illustrates a side elevation view of an implementation of a key of a keyboard, in accordance with embodiments of the present disclosure; and

FIGS. 3A and 3B (collectively referred to as FIG. 3) illustrate a flow chart of an example method for forming the key depicted in FIG. 2, in accordance with embodiments of the present disclosure.

### DETAILED DESCRIPTION

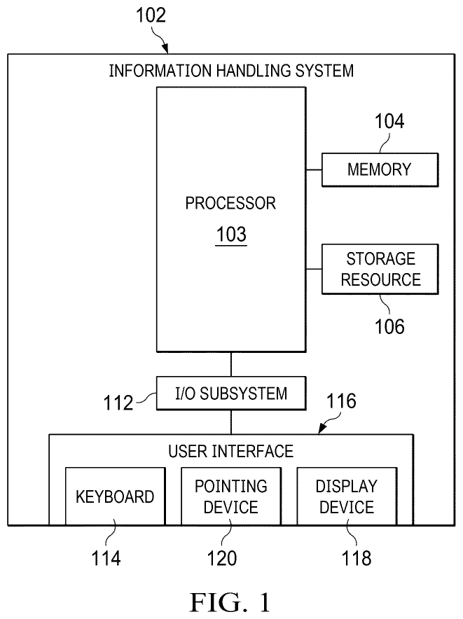

Preferred embodiments and their advantages are best understood by reference to FIGS. 1 through 3, wherein like numbers are used to indicate like and corresponding parts.

For the purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, an information handling system may be a personal computer, a personal digital assistant (PDA), a consumer electronic device, a network storage device, or any other suitable device and may vary in size, shape, performance, functionality, and price. The information handling system may include memory, one or more processing resources such as a central processing unit (“CPU”) or hardware or software control logic. Additional components of the information handling system may include one or more storage devices, one or more communications ports for communicating with external devices as well as various input/output (“I/O”) devices, such as a keyboard, a mouse, and a video display. The information handling system may also include one or more buses operable to transmit communication between the various hardware components.

For the purposes of this disclosure, computer-readable media may include any instrumentality or aggregation of instrumentalities that may retain data and/or instructions for a period of time. Computer-readable media may include, without limitation, storage media such as a direct access storage device (e.g., a hard disk drive or floppy disk), a sequential access storage device (e.g., a tape disk drive), compact disk, CD-ROM, DVD, random access memory (RAM), read-only memory (ROM), electrically erasable programmable read-only memory (EEPROM), and/or flash memory; as well as communications media such as wires, optical fibers, microwaves, radio waves, and other electromagnetic and/or optical carriers; and/or any combination of the foregoing.

For the purposes of this disclosure, information handling resources may broadly refer to any component system, device or apparatus of an information handling system, including without limitation processors, service processors, basic input/output systems (BIOSs), buses, memories, I/O devices and/or interfaces, storage resources, network interfaces, motherboards, and/or any other components and/or elements of an information handling system.

FIG. 1 illustrates a block diagram of an example information handling system 102, in accordance with certain embodiments of the present disclosure. In some embodiments, information handling system 102 may be a server. In other embodiments, information handling system 102 may be a personal computer (e.g., a desktop computer or a portable computer). As depicted in FIG. 1, information handling system 102 may include a processor 103, a memory 104 communicatively coupled to processor 103, a storage resource 106 communicatively coupled to processor 103, an input/output (I/O) subsystem 112 communicatively coupled to processor 103, and a user interface 116 communicatively coupled to I/O subsystem 112.

Processor 103 may include any system, device, or apparatus configured to interpret and/or execute program instructions and/or process data, and may include, without limitation a microprocessor, microcontroller, digital signal processor (DSP), application specific integrated circuit (ASIC), or any other digital or analog circuitry configured to interpret and/or execute program instructions and/or process data. In some embodiments, processor 103 may interpret and/or execute program instructions and/or process data stored in memory 104, storage resource 106, BIOS 110, and/or another component of information handling system 102.

Memory 104 may be communicatively coupled to processor 103 and may include any system, device, or apparatus configured to retain program instructions and/or data for a period of time (e.g., computer-readable media). Memory 104 may include RAM, EEPROM, a PCMCIA card, flash memory, magnetic storage, opto-magnetic storage, or any suitable selection and/or array of volatile or non-volatile memory that retains data after power to information handling system 102 is turned off.

Storage resource 106 may be communicatively coupled to processor 103 and may include any system, device, or apparatus configured to retain program instructions or data for a period of time (e.g., a computer-readable medium). In some embodiments, storage resource 106 may include a hard disk drive, a magnetic tape library, an optical disk drive, a magneto-optical disk drive, a compact disc drive, a solid state storage drive, a flash drive and/or any other suitable computer-readable medium. In some embodiments, storage resource 106 may reside internal to a chassis or other enclosure comprising information handling system 102 and not be readily accessible without opening such chassis or other enclosure. In other embodiments, storage resource 106 may reside internal to a chassis or other enclosure comprising information handling system 102.

I/O subsystem 112 may comprise any suitable system, device, or apparatus generally operable to receive and transmit data to or from or within information handling system 102. I/O subsystem 112 may represent, for example, any one or more of a variety of communication interfaces, graphics interfaces, video interfaces, user input interfaces, and peripheral interfaces.

User interface 116 may comprise any instrumentality or aggregation of instrumentalities by which a user may interact with information handling system 102. For example, user interface 116 may permit a user to input data and/or instructions into information handling system 102 (e.g., via a keyboard 114, a pointing device 120, and/or other suitable component), and/or otherwise manipulate information handling system 102 and its associated components. User interface 116 may also permit information handling system 102 to communicate data to a user, e.g., by way of a display device 118. In some embodiments, display device 118 may include a touchscreen display which may enable user input via display device 118.

Keyboard 114 may comprise any suitable system, device, or apparatus comprising a plurality of alphanumeric keys, function keys, modifier keys, navigation keys, and/or specialized function keys. Such keys may be arranged in rows and columns, with each key inputting a specific character or action to processor 103 when pressed. In some embodiments, keyboard 114 may be partially enclosed within a chassis or housing for information handling system 102, as may be the case for a laptop or notepad computer. In other embodiments, keyboard 114 may comprise a standalone component coupled to the remainder of information handling system 102 via a wired or wireless connection.

Pointing device 120 may comprise any suitable system, device, or apparatus to permit a user to control position of a cursor on display device 118. For example, pointing device 120 may include a mouse, trackball, trackpad, or other suitable device.

Display device 118 may include any system, device, or apparatus configured to generate graphical images and/or reproduce alphanumeric text for viewing by a user of information handling system 102, based on display data communicated to display device 118, processor 103, and/or another component of information handling system 102. Display device 118 may comprise a light-emitting diode display, liquid crystal display, and/or any other suitable display.

In existing approaches, each key may be implemented as a metal plate with a membrane formed atop the metal plate and a backlight below the metal plate. Such membrane may be insulated from the metal plate and may implement a circuit whereby pressure upon the membrane (e.g., from a user pressing a keycap of the key) may complete an electrical circuit, thus indicating the user has pressed the key. However, in accordance with embodiments of the present disclosure, a backlight may be integrated within the membrane layer, and thinner profile insulator may be formed between metallization of the membrane layer and a substrate for the keyboard.

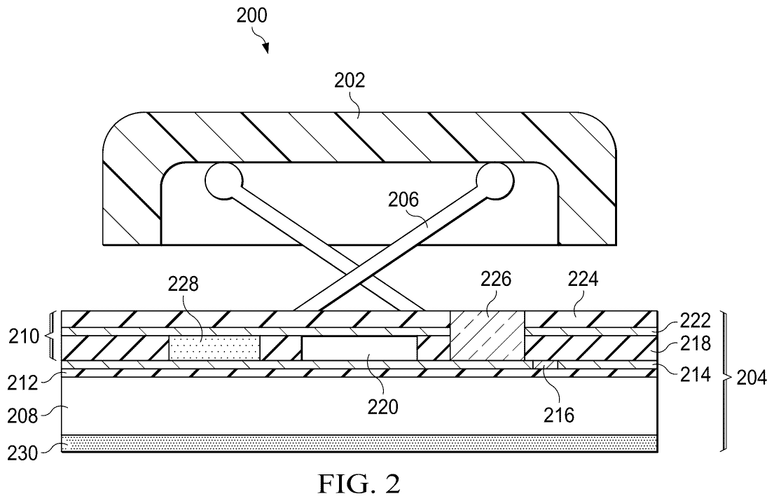

FIG. 2 illustrates a side elevation view of an implementation of a key 200 of keyboard 114, in accordance with embodiments of the present disclosure. As shown in FIG. 2, key 200 may comprise a keycap 202 mechanically coupled to a circuit assembly 204 via a scissor 206.

Keycap 202 may comprise any suitable piece of material (e.g., plastic). Scissor 206 may comprise any suitable mechanical device having a spring force that, in the absence of force applied to keycap 202, maintains a predefined separation between keycap 202 and circuit assembly 204. In operation, a force may be applied (e.g., by the finger of a user) to a top surface of keycap 202 to overcome the spring force of scissor 206, such that keycap 202 may move towards circuit assembly 204. If sufficient force is applied, keycap 202 may mechanically interact with a top surface of circuit assembly 204 which, as described below, may complete an electric circuit indicating that a user has pressed key 200.

Although a scissor 206 is shown in FIG. 2, some keyboards may employ another mechanical component to perform the functionality similar or identical to that of scissor 206.

As shown in FIG. 2, circuit assembly 204 may include a substrate 208 mechanically coupled to a circuit 210 via an electrically-insulating layer 212.

Substrate 208 may comprise any suitable material, including without limitation a metal. As shown in FIG. 2, a waterproofing layer 230 (e.g., made of biaxially oriented polyethylene terephthalate, often more commonly known by its tradename MYLAR) may be formed on the bottom of substrate 208.

Electrically-insulating layer 212 may include any suitable electrically-insulating material, including without limitation a polyimide plastic.

As shown in FIG. 2, circuit 210 may comprise a series of layers, including a metal layer 214, a lower electrical-insulating layer 218, a metal layer 222, and an upper electrical-insulating layer 224.

Each metal layer 214, 222 may comprise any suitable electrically conductive metal, including without limitation copper, silver, gold, and/or aluminum. In some embodiments, an electrical circuit may be patterned in one or both of metal layers 214, 222.

Each of lower electrical-insulating layer 218 and upper electrical-insulating layer 224 may include any suitable electrically-insulating material, including without limitation a polyethylene terephthalate.

As also shown in FIG. 2, an illumination source 226 (e.g., a light-emitting diode) may be added upon metal layer 214, for providing lighting for key 200 similarly to how a backlight provides such lighting in traditional approaches. Lower electrical-insulating layer 218, upper electrical-insulating layer 224, and metal layer 222 may be absent on top of the portion of metal layer 214 in which illumination source is placed.

As further shown in FIG. 2, an etch 216 may be formed in metal layer 214 to electrically isolate key 200 from adjacent keys which may be formed upon substrate 208. To that end, while FIG. 2 depicts only a single key 200, some or all of the layers and components depicted in FIG. 2 may be common to multiple keys on a keyboard, with etches or other patterns formed therein to define the individual keys.

Further, an anisotropic conductive film (ACF) 228 may be added at particular locations within key 200 between metal layers 214 and 222 in order to facilitate desired connectivity between metal layers 214 and 222 at selected locations.

As additionally shown in FIG. 2, a through hole 220 may be formed within electrically-insulating layer 218, providing a location in which the membrane formed by lower electrical-insulating layer 218, upper electrical-insulating layer 224, and metal layer 222 may mechanically deflect in response to force applied by keycap 202, causing metal layer 222 to contact metal layer 214 through such through hole 220 to complete a circuit to indicate that key 200 has been pressed by a user.

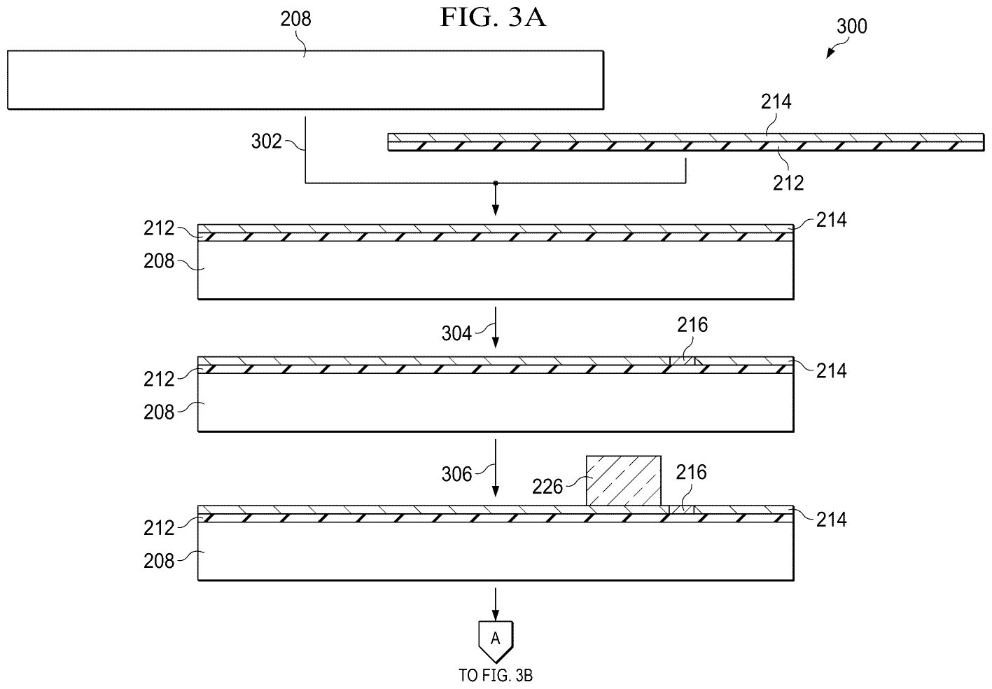

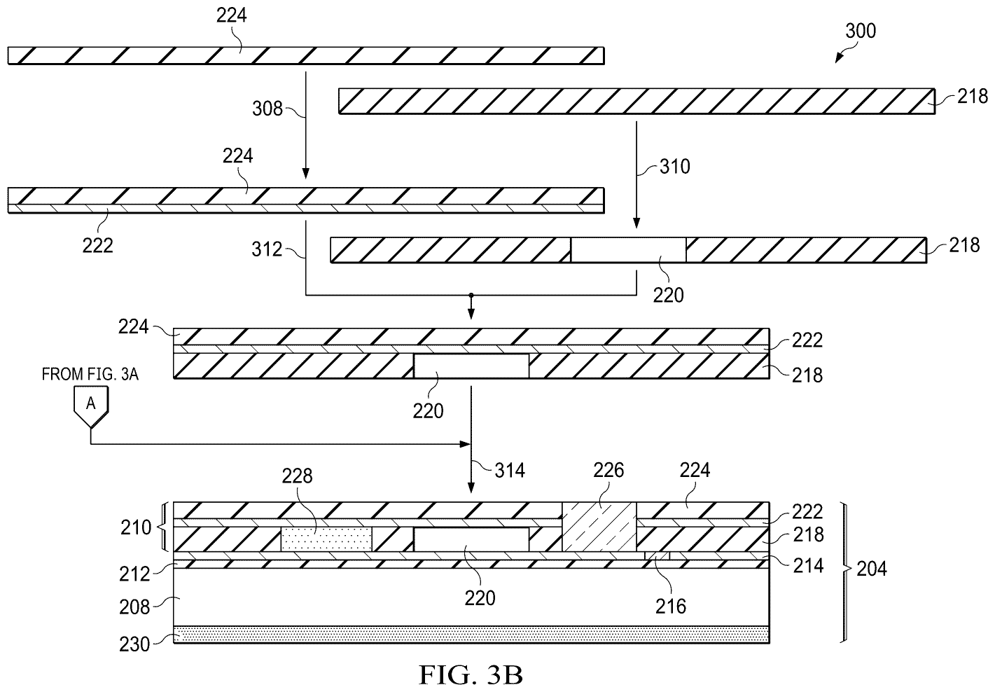

FIG. 3 illustrates a flow chart of an example method 300 for forming key 200, in accordance with embodiments of the present disclosure. According to one embodiment, method 300 may begin at step 302. However, the preferred initialization point for method 300 and the order of the steps comprising method 300 may depend on the implementation chosen.

At step 302, a film of metal layer 214 (e.g., a film of copper) formed upon electrically-insulating layer 212 may be assembled upon substrate 208. At step 304, etch 216 may be formed within metal layer 214 (e.g., via laser etching or other suitable method). At step 306, illumination source 226 may be mounted upon metal layer 214 and electrically coupled to metal layer 214.

At step 308, metal layer 222 (e.g., silver) may be patterned upon upper electrical-insulating layer 224 (e.g., via a suitable printing technique). At step 310, through hole 220 may be formed in lower electrical-insulating layer 218. At step 312, lower electrical-insulating layer 218 (with through hole 220 formed therein) may be assembled to the structure resulting from step 308.

At step 314, the structure resulting from step 312 may be assembled to the structure resulting from step 306, resulting in circuit assembly 204 to which keycap 202 and scissor 206 may be mechanically coupled to form key 200.

Although FIG. 3 discloses a particular number of steps to be taken with respect to method 300, method 300 may be executed with greater or fewer steps than those depicted in FIG. 3. In addition, although FIG. 3 discloses a certain order of steps to be taken with respect to method 300, the steps comprising method 300 may be completed in any suitable order.

In accordance with the methods and systems described herein, an electrical circuit for a key of a keyboard may be printed, etched, or otherwise patterned on a substrate, effectively replacing a membrane circuit layer as is used in traditional approaches. Further, an illumination source may be mounted on the substrate, replacing a backlit circuit as in traditional approaches. Thus, the keyboard membrane, substrate, and illumination source may be integrated within one component to reduce keyboard thickness and keyboard weight. Further, the methods and systems disclosed herein may enable better cooling of the keyboard as the substrate may be made of metal which has low thermal resistance.

As used herein, when two or more elements are referred to as “coupled” to one another, such term indicates that such two or more elements are in electronic communication or mechanical communication, as applicable, whether connected indirectly or directly, with or without intervening elements.

This disclosure encompasses all changes, substitutions, variations, alterations, and modifications to the example embodiments herein that a person having ordinary skill in the art would comprehend. Similarly, where appropriate, the appended claims encompass all changes, substitutions, variations, alterations, and modifications to the example embodiments herein that a person having ordinary skill in the art would comprehend. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative. Accordingly, modifications, additions, or omissions may be made to the systems, apparatuses, and methods described herein without departing from the scope of the disclosure. For example, the components of the systems and apparatuses may be integrated or separated. Moreover, the operations of the systems and apparatuses disclosed herein may be performed by more, fewer, or other components and the methods described may include more, fewer, or other steps. Additionally, steps may be performed in any suitable order. As used in this document, “each” refers to each member of a set or each member of a subset of a set.

Although exemplary embodiments are illustrated in the figures and described above, the principles of the present disclosure may be implemented using any number of techniques, whether currently known or not. The present disclosure should in no way be limited to the exemplary implementations and techniques illustrated in the figures and described above.

Unless otherwise specifically noted, articles depicted in the figures are not necessarily drawn to scale.

All examples and conditional language recited herein are intended for pedagogical objects to aid the reader in understanding the disclosure and the concepts contributed by the inventor to furthering the art, and are construed as being without limitation to such specifically recited examples and conditions. Although embodiments of the present disclosure have been described in detail, it should be understood that various changes, substitutions, and alterations could be made hereto without departing from the spirit and scope of the disclosure.

Although specific advantages have been enumerated above, various embodiments may include some, none, or all of the enumerated advantages. Additionally, other technical advantages may become readily apparent to one of ordinary skill in the art after review of the foregoing figures and description.

To aid the Patent Office and any readers of any patent issued on this application in interpreting the claims appended hereto, applicants wish to note that they do not intend any of the appended claims or claim elements to invoke 35 U.S.C. § 112(f) unless the words “means for” or “step for” are explicitly used in the particular claim.

What is claimed is:

1. A keyboard comprising a plurality of keys, each key of the plurality of keys comprising:
a circuit assembly comprising:
a substrate;
a first metal layer patterned into a circuit and formed on the substrate; and
a membrane comprising a second metal layer interfaced between a first electrically-insulative layer and a second electrically-insulative layer, and assembled to the first metal layer such that the first electrically-insulative layer is interfaced between the first metal layer and the second metal layer; and
a keycap mechanically coupled to the circuit assembly via a mechanical member having a spring force biased to separate the keycap from the circuit assembly by a predetermined distance, such that when a force is applied to the keycap to overcome the spring force, the first metal layer comes in physical contact with the second metal layer.

2. The keyboard of claim 1, further comprising an illumination source mounted to the first metal layer.

3. The keyboard of claim 1, wherein the first metal layer comprises copper.

4. The keyboard of claim 1, wherein the first metal layer comprises silver.

5. The keyboard of claim 1, wherein the substrate comprises metal.

6. The keyboard of claim 5, further comprising a third electrically-insulative layer interfaced between the substrate and the first metal layer.

7. An information handling system comprising:
a processor; and
a keyboard communicatively coupled to the processor, the keyboard comprising a plurality of keys, each key of the plurality of keys comprising:
a circuit assembly comprising:
a substrate;
a first metal layer patterned into a circuit and formed on the substrate; and
a membrane comprising a second metal layer interfaced between a first electrically-insulative layer and a second electrically-insulative layer, and assembled to the first metal layer such that the first electrically-insulative layer is interfaced between the first metal layer and the second metal layer; and
a keycap mechanically coupled to the circuit assembly via a mechanical member having a spring force biased to separate the keycap from the circuit assembly by a predetermined distance, such that when a force is applied to the keycap to overcome the spring force, the first metal layer comes in physical contact with the second metal layer.

8. The information handling system of claim 7, further comprising an illumination source mounted to the first metal layer.

9. The information handling system of claim 7, wherein the first metal layer comprises copper.

10. The information handling system of claim 7, wherein the first metal layer comprises silver.

11. The information handling system of claim 7, wherein the substrate comprises metal.

12. The information handling system of claim 11, further comprising a third electrically-insulative layer interfaced between the substrate and the first metal layer.

13. A method for making a keyboard, comprising assembling a circuit assembly by:
patterning a first metal layer into a circuit on a substrate;
interfacing a membrane comprising a second metal layer between a first electrically-insulative layer and a second electrically-insulative layer; and
assembling the membrane to the first metal layer such that the first electrically-insulative layer is interfaced between the first metal layer and the second metal layer.

14. The method of claim 13, further comprising mechanically coupling a keycap to the circuit assembly via a mechanical member having a spring force biased to separate the keycap from the circuit assembly by a predetermined distance, such that when a force is applied to the keycap to overcome the spring force, the first metal layer comes in physical contact with the second metal layer.

15. The method of claim 13, further comprising mounting an illumination source to the first metal layer.

16. The method of claim 13, wherein the first metal layer comprises copper.

17. The method of claim 13, wherein the first metal layer comprises silver.

18. The method of claim 13, wherein the substrate comprises metal.

19. The method of claim 18, further comprising interfacing a third electrically-insulative layer between the substrate and the first metal layer.
